(19) United States
(12) Patent Application Publication
(10) Pub. No.: US 2005/0052020 A1
(43) Pub. Date: Mar. 10, 2005

(54) Assembly for attaching a clamp to a hose

(76) Inventor: Jay T. Butler, Birmingham, AL (US)

Correspondence Address: DAYCO PRODUCTS, LLC, 1 PRESTIGE PLACE, MIAMISBURG, OH, 45342, US

(21) Appl. No.: 10/657,572

(22) Filed: Sep. 5, 2003

(51) Int. Cl. F16L 55/00

(52) U.S. Cl. 285/23; 285/253

(57) ABSTRACT

A clamp assembly comprising a clamp including a band having and a screw housing mounted to said band with a worm screw disposed in said screw housing, said worm screw engaging said band for tightening said band; and a cover bracket having an opening receiving said screw housing, said cover bracket including a cover portion for the screw housing and a bonding surface extending from the cover for attaching the cover bracket to a hose, the bonding surface extending from the cover portion to a position on the hose that is displaced from the screw and the screw housing such that the cover bracket can be adhered to the hose without interfering with the clamp assembly.

### SUMMARY OF THE INVENTION

A cover bracket is provided for attaching a screw clamp to a hose. The cover bracket may be made of plastic and includes a bonding surface that extends from the cover portion of the bracket. In one embodiment, the bonding surface is a pair of runners. In another embodiment, the runners have a curvature similar to outer surface of the hose. In still another embodiment, the runners extend to a position on the hose which is sufficiently displaced from the screw mechanism that adhesive can be easily applied to the bracket and the bracket assembled with the hose, without interfering with the screw mechanism.

In a further embodiment of the invention, to prevent the screw housing from traveling within the cover portion of the bracket, the inside walls of the cover portion are inset so as to capture the screw housing and prevent such travel.

### BRIEF DESCRIPTION OF THE DRAWINGS

The objects, features and advantages of the invention will appear more fully hereinafter as the description thereof proceeds, reference being made to the accompanying drawings in which:

FIG. 1 illustrates a perspective view of a bracket in accordance with one embodiment of the invention assembled with the hose.

FIG. 2 illustrates a perspective view of a bracket in accordance with one embodiment of the invention prior to assembly with the hose.

FIG. 3 is a cross section of the assembled bracket along the line 3-3 in FIG. 1.

FIG. 4 is a perspective view of a bracket in accordance with one embodiment of the invention.

### DETAILED DESCRIPTION OF THE INVENTION

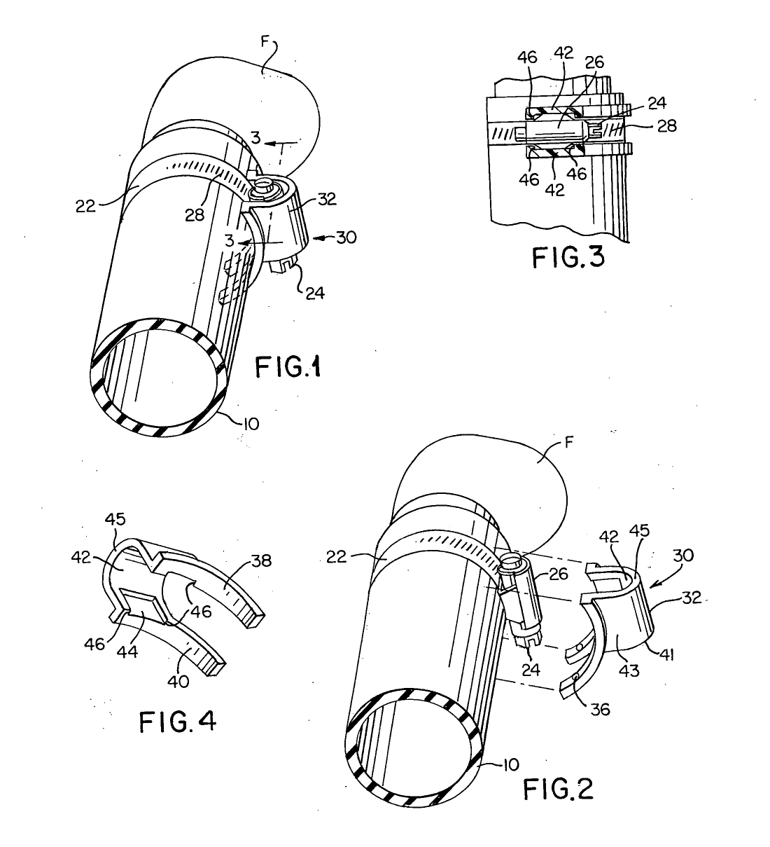

Referring now to the drawings, in particularly FIG. 1, there is illustrated by way of example a conventional automotive hose 10 including a screw clamp mechanism 20. FIG. 1 illustrates the cover bracket 30 in accordance with one embodiment of the present invention in place over the clamp. More specifically, the clamp 20 includes a slotted band 22, a screw 24 and a screw housing 26. As the screw 24 is turned, the threads of the screw 24 engage the slots 28 on the band 22 of the clamp 20. This draws the band 22 around the hose 10 thereby tightening the hose onto a fixture (F) to which the hose is mounted.

The cover bracket 30 includes a substantially U-shaped cover portion 32. While the cover portion 32 is illustrated in this embodiment as being U-shaped, those skilled in the art will recognize that the cover portion can be substantially any shape which captures and contains the screw housing 26. For example, the cover portion 32 could be rectangular, semicircular or polygonal.

A bonding surface 34 extends from the cover portion 32. A deposit of an adhesive 36 is provided on the bonding surface 34 for securing the cover bracket 30 to the hose 10 as shown in FIG. 2. In this embodiment, the bonding surface is formed on two runners 38 and 40 which are spaced apart a distance that is approximately equal to the width of the band 22. The runners 38 and 40 are long enough that adhesive can be applied to the distal portion of the runners without contaminating the screw 24, the screw housing 26, or the slotted portion of the band 22. In the illustrated embodiment, the runners 38 and 40 extend from the sidewalls 43 and the back wall 41 of the cover portion 32. However, in another embodiment of the invention, the runners 38 and 40 may alternatively extend from the front wall 45 of the cover portion, or the runners may extend from the front and back walls to provide a C-shaped runner such that adhesive can be applied both in front of and behind the screw housing 26.

The inside surface 42 of the sidewalls 43 includes a set-in portion 44. This set-in portion is sized and shaped to contain the screw housing 26. As a result of forming the set-in portion 44 in the sidewalls 43, a stop 46 is formed on the inside of the front and back walls of the cover portion 32 which prevents the screw housing from moving inside the cover bracket 30. In this manner upon turning the screw 24, as a result of the detents 46, the band is drawn through the screw housing and the screw housing does not move with respect to the cover bracket 30.

The cover bracket 30 can be formed from any suitable material, for example, it may be metallic, non-metallic, plastic, etc. Preferably the cover bracket is formed from a hard plastic, and, still more particularly it is formed from an extrusion molded plastic such as nylon or high density polyethylene (HDPE).

A variety of adhesives or glues may be used to secure the cover bracket to the hose. One useful glue is a cyanoacrylate. Preferably an adhesive or glue is selected which cures rapidly to facilitate assembly of the cover bracket and the clamp with the hose.

In the illustrated embodiment, the inside spacing of the sidewalls 42 is approximately equal to the width of the clamp. To assemble the clamp with the hose, the clamp 20 is placed over the end of the hose in the position in which the screw is accessible for installation. The cover bracket 30 is placed over the screw housing 26 with the adhesive deposits 36 on the runners 38 and 40 in contact with the outer surface of the hose 10. The cover bracket is held in place, for example using a clamp, until the adhesive hardens. Alternatively, the inside walls 42 of the cover bracket 30 may include opposing inwardly directed flanges (not shown). In this case, the clamp can be assembled with the hose by feeding the band into the cover portion 32 of the cover bracket and sliding the band over the end of the hose. In this embodiment, the band is able to hold the cover bracket 30 in place on the hose 10 while the adhesive deposit 36 hardens.

Those skilled in the art will recognize that the cover bracket of the invention is useful in any application in which it may be desirable to supply a clamp affixed to a hose. The hose may be a fuel fill hose, radiator hose, heater hose, etc.

Having described the invention in detail and by reference to specific embodiments thereof, it will be apparent that numerous modifications and variations are possible without departing from the spirit and scope of the following claims.

1. A clamp and hose assembly comprising:
a hose,
a clamp including a band having and a screw housing mounted to said band with a screw disposed in said screw housing, said screw engaging said band for tightening said band;
a cover bracket having an opening receiving said screw housing, said cover bracket including a cover portion for the screw housing and a bonding surface extending from the cover portion for attaching the cover bracket to a hose, the bonding surface extending from the cover portion to a position on the hose that is displaced from the screw and the screw housing; and
an adhesive applied to the portion of the bonding surface displaced from the screw and screw housing, such that the cover bracket is adhered to the hose without interfering with the clamp operation.

2. The assembly of claim 1 wherein the bonding surface includes a pair of runners extending from the base of the cover.

3. The assembly of claim 2 wherein the runners are curved.

4. The assembly of claim 3 wherein the curvature of the runners is approximately the same curvature as the hose.

5. The assembly of claim 4 wherein the cover has an inverted U-shaped cross-section.

6. The assembly of claim 5 wherein the cover includes an inside surface having an inset that retains the screw housing within the cover when the screw is operated.

7. The assembly of claim 1 wherein the cover is made from nylon or high density polyethylene (HDPE).

8. A cover bracket for attaching a clamp having a screw and screw housing to a hose comprising:
a cover portion that enclosed the screw housing when assembled with a hose;
a bonding surface extending from the cover portion to a position on the hose that is displaced from the screw and the screw housing; and
an adhesive applied to the portion of the bonding surface displaced from the screw and screw housing, such that the cover bracket is adhered to the hose without interfering with the clamp assembly.

9. The bracket of claim 8 wherein the bonding surface includes a pair of runners extending from the base of the cover.

10. The bracket of claim 9 wherein the runners are curved.

11. The bracket of claim 10 wherein the curvature of the runners is approximately the same curvature as the hose.

12. The bracket of claim 11 wherein the cover has an inverted U-shaped cross-section.

13. The bracket of claim 12 the cover includes an inside surface having an inset that retains the screw housing within the cover when the screw is operated.

14. The bracket of claim 1 wherein the bracket is made from nylon or HDPE.

15. A clamp and hose assembly comprising:
a hose,
a clamp including a band having and a screw housing mounted to said band with a screw disposed in said screw housing, said screw engaging said band for tightening said band;
a cover bracket having an opening receiving said screw housing, said cover bracket including a cover portion for the screw housing and a pair of runners, said runners extending from the cover portion to a position on the hose that is displaced from the screw and the screw housing; and
an adhesive applied to the portion of the runners displaced from the screw housing without contaminating the screw or the screw housing, such that the cover bracket is adhered to the hose.

16. The assembly of claim 15 wherein the screw includes a screw head and the cover is substantially coterminous with the screw housing.

17. The assembly of claim 16 wherein the runners extend from a part of the cover proximate to the screw head.

18. The assembly of claim 16 wherein the runners extend from a part of the cover distal from the screw head.

19. The assembly of claim 15 wherein the runners are C-shaped, extending from a part of the cover proximate to the screw head and a part of the cover distal from the screw head, and the adhesive is applied to the portion of the C-shaped runners displaced from the screw and screw housing.

20. The assembly of claim 15 wherein the cover includes an inside surface having an inset that retains the screw housing within the cover when the screw is operated.

21. The assembly of claim 15 wherein the bracket is made from nylon or HDPE.
